(19) United States
(12) Patent Application Publication
(10) Pub. No.: US 2026/0032670 A1
(43) Pub. Date: Jan. 29, 2026

(54) METHODS AND APPARATUSES FOR DOWNLINK TRANSMISSION IN A FULL DUPLEX SYSTEM

(71) Applicant: LENOVO (BEIJING) LIMITED, Beijing (CN)

(72) Inventors: Yuantao Zhang, Beijing (CN); Ruixiang Ma, Beijing (CN); Hongmei Liu, Beijing (CN); Zhi Yan, Beijing (CN); Haiming Wang, Beijing (CN)

(21) Appl. No.: 19/099,081

(22) PCT Filed: Jul. 29, 2022
(86) PCT No.: PCT/CN2022/108952

§ 371 Date: Jan. 28, 2025

(51) Int. Cl. H04W 72/1263; H04L 5/14; H04W 72/23

(52) U.S. Cl. CPC H04W 72/1263; H04L 5/14; H04W 72/23

(57) ABSTRACT

Embodiments of the present disclosure relate to methods and apparatuses for downlink (DL) transmission in a full duplex (FD) system. According to some embodiments of the present disclosure, a user equipment (UE) may include: a transceiver configured to receive configuration information which configures at least one subband; and a processor coupled to the transceiver and configured to determine, based on an indication, an active subband from the at least one subband for physical downlink shared channel (PDSCH) rate match or for uplink (UL) transmission or that none of the at least one subband is activated for PDSCH rate match.

### TECHNICAL FIELD

Embodiments of the present disclosure generally relate to wireless communication technology, and more particularly to methods and apparatuses for downlink (DL) transmission in a full duplex (FD) system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, the term “duplex” may mean bidirectional communications between two devices, in which “full duplex” means that a transmission over a link in each direction takes place at the same time and “half duplex” means that a transmission over a link in each direction takes place at mutual exclusive time. Details regarding DL transmission in a full duplex system need to be studied.

### SUMMARY

Some embodiments of the present disclosure provide a user equipment (UE). The UE may include: a transceiver configured to receive configuration information which configures at least one subband; and a processor coupled to the transceiver and configured to determine, based on an indication, an active subband from the at least one subband for physical downlink shared channel (PDSCH) rate match or for uplink (UL) transmission or that none of the at least one subband is activated for PDSCH rate match.

In some embodiments of the present disclosure, the configuration information is included in a first radio resource control (RRC) signaling, and the at least one subband is configured for PDSCH rate match.

In some embodiments of the present disclosure, the first RRC signaling is different from a second RRC signaling configuring a UL subband(s) for UL transmission.

In some embodiments of the present disclosure, the at least one subband is a UL subband(s) configured for UL transmission.

In some embodiments of the present disclosure, a subband from the at least one subband is associated with a UL subband configured for UL transmission.

In some embodiments of the present disclosure, the indication is included in a downlink control information (DCI), and the indication indicates that a subband of the at least one subband is the active subband for PDSCH rate match or indicates that none of the at least one subband is activated for PDSCH rate match.

In some embodiments of the present disclosure, the indication indicates to activate a rate match pattern group including a rate match pattern associated with a subband of the at least one subband or indicates that no rate match pattern group including a rate match pattern associated with the at least one subband is activated for PDSCH rate match, and determining the active subband from the at least one subband for PDSCH rate match comprises: determining that the subband is the active subband for PDSCH rate match.

In some embodiments of the present disclosure, the processor is further configured to: perform a rate match around the subband for a PDSCH transmission in a time unit with a UL subband in the case that resources allocated for the PDSCH transmission in the time unit includes the subband.

In some embodiments of the present disclosure, the processor is further configured to: determine the whole resources of the at least one subband are available for a PDSCH transmission in a time unit with a UL subband in the case that none of the at least one subband is activated for PDSCH rate match.

In some embodiments of the present disclosure, the configuration information is included in RRC signaling configuring a UL bandwidth part (BWP).

In some embodiments of the present disclosure, the at least one subband comprises at least one UL subband configured for at least one of UL transmission or PDSCH rate match.

In some embodiments of the present disclosure, the indication is included in a DCI, and the indication indicates that a first UL subband of the at least one UL subband is the active subband for PDSCH rate match or for UL transmission or indicate that none of the at least one UL subband is activated for PDSCH rate match.

In some embodiments of the present disclosure, the processor is further configured to: perform a rate match around the first UL subband for a PDSCH transmission in a time unit with a second UL subband of the at least one UL subband for UL transmission in the case that resources allocated for the PDSCH transmission in the time unit includes the first UL subband.

In some embodiments of the present disclosure, the process is further configured to override a second UL subband of the at least one UL subband which is configured for a UL transmission with the first UL subband for a UL transmission within a time period.

In some embodiments of the present disclosure, the DCI is a DCI scheduling a PDSCH transmission or a group common DCI dedicated for active subband indication.

Some embodiments of the present disclosure provide a base station (BS). The BS may include: a transceiver configured to transmit configuration information which configures at least one subband; and a processor coupled to the transceiver and configured to determine, based on an indication, an active subband from the at least one subband for PDSCH rate match or for UL transmission or that none of the at least one subband is activated for PDSCH rate match.

In some embodiments of the present disclosure, the configuration information is included in a first RRC signaling, and the at least one subband is configured for PDSCH rate match.

In some embodiments of the present disclosure, the first RRC signaling is different from a second RRC signaling configuring a UL subband(s) for UL transmission.

In some embodiments of the present disclosure, the at least one subband is a UL subband(s) configured for UL transmission.

In some embodiments of the present disclosure, a subband from the at least one subband is associated with a UL subband configured for UL transmission.

In some embodiments of the present disclosure, the indication is included in a DCI, and the indication indicates that a subband of the at least one subband is the active subband for PDSCH rate match or indicates that none of the at least one subband is activated for PDSCH rate match.

In some embodiments of the present disclosure, the indication indicates to activate a rate match pattern group including a rate match pattern associated with a subband of the at least one subband or indicates that no rate match pattern group including a rate match pattern associated with the at least one subband is activated for PDSCH rate match, and determining the active subband from the at least one subband for PDSCH rate match comprises: determining that the subband is the active subband for PDSCH rate match.

In some embodiments of the present disclosure, the processor is further configured to: perform a rate match around the subband for a PDSCH transmission in a time unit with a UL subband in the case that resources allocated for the PDSCH transmission in the time unit includes the subband.

In some embodiments of the present disclosure, the processor is further configured to: determine the whole resources of the at least one subband are available for a PDSCH transmission in a time unit with a UL subband in the case that none of the at least one subband is activated for PDSCH rate match.

In some embodiments of the present disclosure, the configuration information is included in RRC signaling configuring a UL BWP.

In some embodiments of the present disclosure, the at least one subband comprises at least one UL subband configured for at least one of UL transmission or PDSCH rate match.

In some embodiments of the present disclosure, the indication is included in a DCI, and the indication indicates that a first UL subband of the at least one UL subband is the active subband for PDSCH rate match or for UL transmission or indicate that none of the at least one UL subband is activated for PDSCH rate match.

In some embodiments of the present disclosure, the processor is further configured to: perform a rate match around the first UL subband for a PDSCH transmission in a time unit with a second UL subband of the at least one UL subband for UL transmission in the case that resources allocated for the PDSCH transmission in the time unit includes the first UL subband.

In some embodiments of the present disclosure, the process is further configured to override a second UL subband of the at least one UL subband which is configured for a UL transmission with the first UL subband for a UL transmission within a time period.

In some embodiments of the present disclosure, the DCI is a DCI scheduling a PDSCH transmission or a group common DCI dedicated for active subband indication.

Some embodiments of the present disclosure provide a method performed by a UE. The method may include: receiving configuration information which configures at least one subband; and determining, based on an indication, an active subband from the at least one subband for PDSCH rate match or for UL transmission or that none of the at least one subband is activated for PDSCH rate match.

Some embodiments of the present disclosure provide a method performed by a BS. The method may include: transmitting configuration information which configures at least one subband; and determining, based on an indication, an active subband from the at least one subband for PDSCH rate match or for UL transmission or that none of the at least one subband is activated for PDSCH rate match.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system according to some embodiments of the present disclosure;

FIG. 2 illustrates exemplary duplex modes according to some embodiments of the present disclosure;

FIG. 3 illustrates exemplary radio resources in a time division duplex (TDD) system according to some embodiments of the present disclosure;

FIG. 4 illustrates exemplary resource allocation type 0 and resource allocation type 1 according to some embodiments of the present disclosure;

FIG. 5 illustrates exemplary reserved resources for DL transmissions according to some embodiments of the present disclosure.

FIG. 6 is a flow chart illustrating an exemplary method for DL transmission in a full duplex system according to some embodiments of the present disclosure;

FIGS. 7 and 8 are exemplary methods for determining a subband for PDSCH rate match according to some embodiments of the present disclosure;

FIG. 9 is an exemplary method for overriding a subband according to some embodiments of the present disclosure;

FIG. 10 is a flow chart illustrating an exemplary method for DL transmission in a full duplex system according to some embodiments of the present disclosure; and

FIG. 11 illustrates a simplified block diagram of an exemplary apparatus for DL transmission in a full duplex system according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

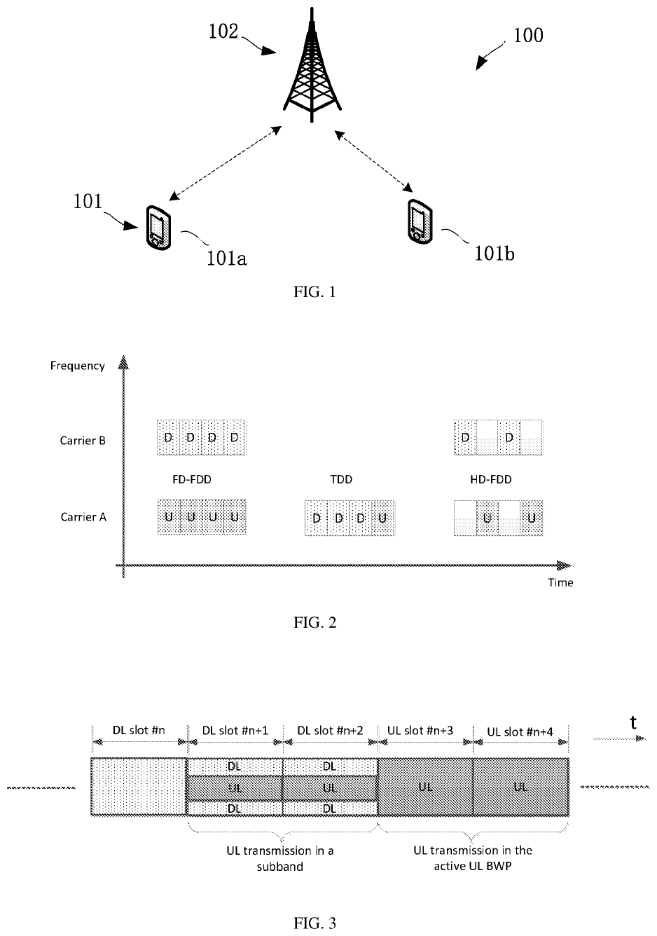

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a BS (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via UL communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via DL communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally. however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In a wireless communication system, the term “duplex” may mean bidirectional communications between two devices, in which “full duplex” means that a transmission over a link in each direction takes place at the same time and “half duplex” means that a transmission over a link in each direction takes place at mutual exclusive time.

FIG. 2 illustrates exemplary duplex modes according to some embodiments of the present disclosure.

Referring to FIG. 2, duplex modes may include, for example, a full duplex frequency division duplex (FD-FDD) mode, a TDD mode, and a half duplex frequency division duplex (HD-FDD) mode.

In some examples, in a full duplex transceiver, different carrier frequencies (e.g., carrier A and carrier B) may be employed for transmissions in each link direction, for example, carrier A may be used for the uplink transmissions while carrier B may be used for the downlink transmissions. Such kind of full duplex may be referred to as the FD-FDD mode.

In a half duplex (HD) transceiver, transmissions in each link direction may be separated by time domain resources. In some cases, the same carrier frequency is used for transmissions in each link direction, for example, carrier A is used for both the uplink and downlink transmissions, whereby such kind of half duplex may be referred to as the TDD mode. In some other cases, different carrier frequencies may be used for transmissions in each link direction, for example, carrier A may be used for the uplink transmissions while carrier B may be used for the downlink transmissions, whereby such kind of half duplex may be referred to as the HD-FDD mode.

Embodiments of the present disclosure provide improvements on the duplex modes, for example, as illustrated in FIG. 2. For example, advanced full duplex modes which enable simultaneous transmission and reception by the same device on the same carrier are provided. The advanced full duplex modes are advantageous. For example, the advanced full duplex modes may improve link throughput. In addition, transmission latency in the advanced full duplex modes may also be reduced due to simultaneous bidirectional transmission.

However, simultaneous DL transmission and UL transmission in the same carrier may incur self-interference. For example, on the BS side, the DL transmission may contaminate UL reception, while on the UE side, the UL transmission may contaminate DL reception.

It is more feasible to realize a full duplex on the BS side than on the UE side due to the following reasons. First, more space is available on the BS side such that transmitter (Tx) and receiver (Rx) antenna branches can be separated for self-interference cancellation. In addition, a more complex and advanced transceiver can be used on the BS side, which may be fundamental for self-interference cancellation.

Given the above, one scenario for implementing a full duplex mode is to deploy a full duplex mode on the BS side only, while still deploying a half duplex mode on the UE side. In such scenario, in a time unit (e.g., in terms of slot, symbol, sub-slot, etc.) with a full duplex mode, the BS may perform UL receptions from some UEs while performing DL transmissions to some other UEs. Non-overlapped frequency resources in the time unit may be allocated for UL receptions (from some UEs) and DL transmissions (to some other UEs) to mitigate self-interference. Such kind of full duplex mode may be referred to as a subband full duplex (SBFD).

The SBFD may be used in a TDD system to improve UL performance in the TDD system. For example, with the SBFD on the BS side, a UL subband(s) may be configured in some DL slots such that the UL transmission can be extended to be within such UL subband(s) in the DL slots while the DL transmission may be scheduled in the resources out of the UL subband(s). Here a subband corresponds to a set of frequency domain resources, e.g., a set of resource elements (REs) or resource blocks (RBs), and may be applicable to a time duration that is configured by a BS. Although the terminology “subband” is used for describing the embodiments of the present disclosure, other terminologies that correspond to a similar resource allocation to the subband, such as bandwidth part, are also applicable to the embodiments of the present disclosure.

FIG. 3 illustrates exemplary radio resources in a time division duplex (TDD) system according to some embodiments of the present disclosure.

In some examples, in a TDD system, DL transmissions and UL transmissions may be separated by time domain resources (e.g., slots). For example, the DL transmissions may be performed in DL slots #n-#n+2 as shown in FIG. 3 while the UL transmissions may be performed in the UL slots #n+3-#n+4 as shown in FIG. 3.

The SBFD on the BS side may be introduced to the TDD system. For example, for the UEs supporting the SBFD on the BS side, in addition to the UL transmission which may be scheduled in the active UL bandwidth parts (BWPs) in the UL slots, the UL transmission may also be scheduled in a subband in the DL slots in the TDD system. As shown in FIG. 3, UL transmissions may occur in a subband in DL slots #n+1 and #n+2. In other words, slot #n+1 and #n+2 are configured with a UL subband(s).

In some embodiments of the present disclosure, two resource allocation types may be used for frequency domain resource allocation for DL transmission (e.g., PDSCH transmission). For example, the two resource allocation types may be referred to as resource allocation type 0 (also referred to as type 0) and resource allocation type 1 (also referred to as type 1).

Resource allocation type 0 is a bitmap-based resource allocation scheme, wherein each bit may indicate whether a corresponding resource block (RB) group (RBG) is used for a PDSCH transmission, wherein each RBG may include more than one RB. Resource allocation type 1 uses a start position and a length of the RB allocation to indicate a resource allocation for a PDSCH transmission.

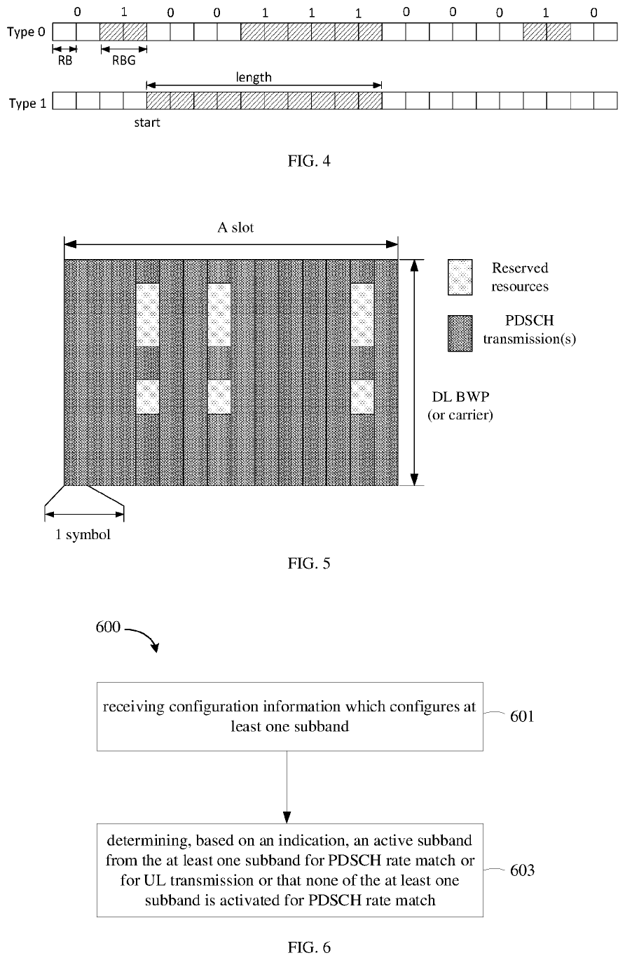

FIG. 4 illustrates an exemplary resource allocation type 0 and an exemplary resource allocation type 1 according to some embodiments of the present disclosure. In the example of FIG. 4, it is assumed that a BWP includes 24 RBs.

Referring to resource allocation type 0 (e.g., Type 0) in FIG. 4, each RBG may include two RBs. A UE may receive a bitmap “010011100010” indicating a resource allocation in the BWP for a PDSCH transmission, wherein “0” indicates that the corresponding RBG is not used for the PDSCH transmission, whereas “1” indicates that the corresponding RBG is used for the PDSCH transmission.

Referring to resource allocation type 1 (e.g., Type 1) in FIG. 4, a UE may receive information indicating a resource allocation in the BWP for a PDSCH transmission. The information may indicate a start position (e.g., the fifth RB in the BWP) of the resource allocation and a length (e.g., 10 RBs) of the resource allocation.

Compared with resource allocation type 1, resource allocation type 0 may have better resource allocation flexibility by supporting discontinuous allocation and arbitrary RBG allocation for a PDSCH transmission, but have higher resource allocation overhead. In addition, since the minimum scheduling granularity in resource allocation type 0 is an RBG, it supports a relatively large granularity for resource allocation. In contrast, resource allocation type 1 has lower overhead but reduced resource allocation flexibility since it only supports continuous allocation (e.g., which may rely on virtual resource block (VRB)-physical resource block (PRB) mapping to achieve frequency diversity).

For example, for a BWP including 36 RBs, assuming that a RBG includes 2 RBs, then 18 bits are needed for indicating resource allocation when using resource allocation type 0, whereas only 10 bits are needed for indicating resource allocation when using resource allocation type 1. In some cases, the BS may configure a larger size RBG to reduce the number of bits required when using resource allocation type 0. However, the scheduling flexibility may be sacrificed due to a larger scheduling granularity.

In some embodiments, a UE may receive, from a BS, RRC signaling indicating a resource allocation type used for PDSCH resource allocation. In some embodiments, a UE may receive, from a BS, DCI to indicate a dynamic switching between resource allocation type 0 and resource allocation type 1. However, such indicating may depend on UE's capability regarding whether to support a dynamic switching between resource allocation type 0 and resource allocation type 1.

In some embodiments of the present disclosure, reserved resources for DL transmission (i.e., PDSCH transmission) are introduced. One purpose for introducing reserved resources for DL transmission is to allow future extensions without causing a backward compatibility issue. For example, the reserved resources cannot be used for DL transmission for legacy UEs, but could be used for future services. Another purpose for introducing reserved resources for DL transmission is to allow reusing unused CORESET resources for PDSCH transmission.

In some embodiments, the reserved resources may be semi-statically configured by RRC signaling. For example, the RRC signaling may include configurations of one or more rate match patterns for a DL transmission (e.g., PDSCH transmission). A configuration (e.g., RateMatchPattern as specified in 3GPP standard documents) of a rate match pattern may indicate reserved resources for the DL transmission (e.g., PDSCH transmission).

In an embodiment of the present disclosure, a rate match pattern may be configured in a cell level (e.g., in a signaling servingCellConfig or servingCellConfigCommon as specified in 3GPP standard documents). In another embodiment of the present disclosure, a rate match pattern may be configured in a BWP level (e.g., in a PDSCH-config information element (IE) in a singling BWP-ConfigDedicated as specified in 3GPP standard documents).

FIG. 5 illustrates exemplary reserved resources for DL transmission according to some embodiments of the present disclosure.

Referring to FIG. 5, it illustrates a slot in the time domain and a DL BWP or a carrier in the frequency domain. For example, the slot in FIG. 5 may include 14 symbols. A configuration of a rate match pattern may indicate the reserved resources as shown in FIG. 5. The resources other than the reserved resources may be used for a PDSCH transmission(s). For example, when the resources allocated for a PDSCH transmission include the reserved resources, the UE may perform a PDSCH rate match around the reserved resources.

According to some embodiments of the present disclosure, one or more rate match pattern groups for DL transmission (e.g., PDSCH transmission) may be configured by RRC signaling. For example, the RRC signaling may include configurations of one or more rate match pattern groups (e.g., ratematchpatterngroup1 and ratematchpatterngroup2 as specified in 3GPP standard documents) for DL transmission (e.g., PDSCH transmission). A configuration of a rate match pattern group may indicate one or more rate match patterns.

A rate match pattern group may be dynamically activated or deactivated by, for example, DCI scheduling a DL transmission (e.g., PDSCH transmission) (e.g., by DCI format 1_1 or DCI format 1_2). In the case that a rate match pattern group is activated (also referred to as “reserved resources defined by all rate match patterns in the rate match pattern group are activated”), the DL transmission cannot be transmitted in reserved resources defined by all rate match patterns in the rate match pattern group and may be rate matched around the reserved resources; otherwise (i.e., in the case that the rate match pattern group is deactivated), the reserved resources can be used for DL transmission.

In some embodiments of the present disclosure, for a rate match pattern which is not included in a rate match pattern group, it may be activated or deactivated via RRC signaling (in other words, the reserved resources configured by the rate match pattern may be activated or deactivated via RRC signaling). In some embodiments, the BS and the UE may consider that such rate match pattern is always activated until receiving RRC signaling to deactivate it.

Embodiments of the present disclosure provide solutions for improving resource utilization for a PDSCH transmission in a DL slot with a UL subband. According to some embodiments of the present disclosure, for a DL slot including a UL subband, if the UL subband is fully occupied, the remaining resources of the DL BWP may be allocated for a PDSCH transmission. If the UL subband is partly occupied, the remaining resources of the subband may be allocated for a PDSCH transmission. If the UL subband is not occupied, the whole UL subband may be allocated for a PDSCH transmission.

In order to achieve the above resource allocation methods, one solution is to configure resource allocation type 0 for a UE since resource allocation type 0 may support flexible discontinuous resource allocation. By using resource allocation type 0, the BS can schedule a PDSCH transmission such that the unavailable resources in a UL subband (e.g., the resources occupied by UL signals) are not within the allocated resource for the PDSCH transmission. The disadvantage of this solution is the higher control signaling overhead when the RBG is configured with a small size. In some cases, the BS may configure an RBG with a larger size to reduce the control signaling overhead. However, an RBG with the larger size may lead to less flexible PDSCH scheduling not only in slots with the UL subband, but also in normal DL slots.

To reduce the control signaling overhead, the UE may be configured with a dynamic resource allocation type switch, e.g., resource allocation type 0 may be used for slots with UL subband(s), and resource allocation type 1 may be used for normal DL slots. However, dynamic resource allocation type switch is only optionally supported by a UE, which depends on UE's capability. In addition, resource allocation type 0 does not support a small granularity for resource allocation (e.g., the unit of the resource allocation is an RBG).

Another solution to achieve the above resource allocation methods is configuring resource allocation type 1 for a UE and configuring a rate match pattern which indicates a UL subband as the reserved source for the UE. The rate match pattern may be included in a rate match pattern group, such that when the resources of the UL subband are not used for a physical uplink shared channel (PUSCH) transmission, it can be dynamically deactivated by deactivating the rate match pattern group and used for a PDSCH transmission. However, such dynamic activation or deactivation is also optionally supported by the UE. In addition, in the above solution, the UL subband can only be activated or deactivated as a whole, and thus it cannot fulfil the goal that when the UL subband is partly occupied, the remaining resources may be used for PDSCH transmission.

Embodiments of the present disclosure further provide enhanced solutions for DL transmission in a full duplex system. The enhanced solutions in the embodiments of the present disclosure can at least solve the above technical problems, and improve the resource utilization efficiency for PDSCH transmission in slots with SBFD (e.g., with a UL subband(s)). More details on embodiments of the present disclosure will be described in the following text in combination with the appended drawings.

FIG. 6 is a flow chart illustrating an exemplary method for DL transmission in a full duplex system according to some embodiments of the present disclosure. The method in FIG. 6 may be implemented by a UE (e.g., UE 101 as shown in FIG. 1).

In the exemplary method shown in FIG. 6, in step 601, a UE may receive configuration information which configures at least one subband from a BS (e.g., BS 102 as shown in FIG. 1). In step 603, the UE may determine, based on an indication, an active subband from the at least one subband for PDSCH rate match or for UL transmission or that none of the at least one subband is activated for PDSCH rate match.

According to some embodiments of the present disclosure, the at least one subband may be configured for PDSCH rate match. In such embodiments, the at least one subband for PDSCH rate match and the UL subband for UL transmission may be configured separately. That is, the at least one subband for PDSCH rate match is configured separately from the UL subband(s) configured for UL transmission.

In some embodiments of the present disclosure, the configuration information configuring the at least one subband may be included in an RRC signaling (e.g., RRC signaling #1).

In an embodiment of the present disclosure, RRC signaling #1 may be different from an RRC signaling (e.g., RRC signaling #2) configuring a UL subband(s) for UL transmission.

For example, the at least one subband for PDSCH rate match may be configured cell specifically. For instance, RRC signaling #1 may be RRC signaling (e.g., BWP-DownlinkCommon as specified in 3GPP standard documents) that configures the common part of a DL BWP. RRC signaling #2 may be an RRC signaling (e.g., BWP-UplinkCommon as specified in 3GPP standard documents) that configures the common part of a UL BWP.

By configuring the at least one subband for PDSCH rate match separately, even when a UE is not configured with a UL subband(s) for UL transmission, it could get the subband configuration for PDSCH rate match.

In some embodiments of the present disclosure, a subband of the at least one subband for PDSCH rate match may be associated with a UL subband for UL transmission, e.g., a subband of the at least one subband is configured within a UL subband. In some embodiments of the present disclosure, each subband of the at least one subband for PDSCH rate match may be associated with a corresponding UL subband for UL transmission, e.g., each subband of the at least one subband may be configured within a corresponding UL subband.

According to some embodiments of the present disclosure, if the subband(s) for PDSCH rate match are not configured, the at least one subband (e.g., in step 601) may be the configured UL subband(s) for UL transmission.

In some embodiments of the present disclosure, the at least one subband (e.g., at least one subband for PDSCH rate match or the configured UL subband(s)) may be indexed such that each subband of the at least one subband may have an index. Such index may be used for indicating an active subband from the at least one subband. The specific operation will be illustrated below.

In some embodiments of the present disclosure, the indication may be included in a DCI (e.g., the indication may be a field included in DCI), and indicate that a subband (e.g., denoted as subband #S) of the at least one subband is the active subband for PDSCH rate match or indicates that none of the at least one subband is activated for PDSCH rate match.

For example, the indication may indicate an ID or an index of subband #S from the at least one subband, which means that subband #S is the active subband for PDSCH rate match. In another example, the indication may have a pre-defined value, which means that none of the at least one subband is activated for PDSCH rate match.

In an embodiment, the DCI may be a DCI scheduling a PDSCH transmission. In another embodiment, the DCI may be a group common DCI dedicated for active subband indication.

In such embodiments, the UE may receive the DCI including the indication. Based on the indication, the UE may determine subband #S is the active subband for PDSCH rate match, or determine that none of the at least one subband is activated for PDSCH rate match.

In response to determining that subband #S is the active subband for PDSCH rate match, in the case that resources allocated for a PDSCH transmission in a time unit (e.g., in terms of slot, symbol, sub-slot, etc.) with a UL subband configured for UL transmission include subband #S, the UE may perform a rate match around subband #S for a PDSCH transmission in the time unit.

In response to determining that none of the at least one subband is activated for PDSCH rate match, the UE may determine the whole resources of the at least one subband are available for a PDSCH transmission in a time unit with a UL subband configured for UL transmission.

In some embodiments of the present disclosure, a rate match pattern may be used to configure the resources of a subband within the at least subband. In such embodiments, a rate match pattern may be associated with a subband within the at least subband. For example, the rate match pattern may be configured with an ID or an index of the subband (in other words, a configuration for the rate match pattern may include an ID or an index of the subband) such that the reserved resources indicated by the rate match pattern correspond to the subband. In such embodiments, the rate match pattern may be included in a rate match pattern group.

For example, assuming that the at least one subband includes five subbands (e.g., denoted as subbands #0-#4). Each subband may be associated with a corresponding rate match pattern, e.g., rate match pattern #0 may be configured with an index of subband #0, rate match pattern #1 may be configured with an index of subband #1, rate match pattern #2 may be configured with an index of subband #2 rate match pattern #3 may be configured with an index of subband #3, and rate match pattern #4 may be configured with an index of subband #4. Each rate match pattern may be included in a corresponding rate match pattern group, e.g., rate match patterns #0-#4 may be included in rate match pattern groups #0-#4, respectively.

In such embodiments, the indication may indicate to activate a rate match pattern group (e.g., rate match pattern group #0) including a rate match pattern associated with a subband of the at least one subband or indicate no rate match pattern group(s) including a rate match pattern(s) associated with the at least one subband is activated for PDSCH rate match (e.g., none of rate match pattern groups #0-#4 is activated for PDSCH rate match).

In an embodiment, the indication may be included in a DCI (e.g., the indication may be a field included in DCI). For example, the DCI may be a DCI scheduling a PDSCH transmission. In another embodiment, the DCI may be a group common DCI dedicated for active subband indication.

In such embodiments, the UE may receive the indication. In the case that the indication indicates to activate a rate match pattern group (e.g., rate match pattern group #0) including a rate match pattern associated with a subband of the at least one subband, the UE may determine that subband #0 is the active subband for PDSCH rate match. In the case that the indication indicates no rate match pattern group(s) including a rate match pattern(s) associated with the at least one subband is activated for PDSCH rate match, the UE may determine that none of the at least one subband is activated for PDSCH rate match.

In response to determining that subband #0 is the active subband for PDSCH rate match, in the case that resources allocated for a PDSCH transmission in a time unit with a UL subband configured for UL transmission include subband #0, the UE may perform a rate match around subband #0 for a PDSCH transmission in the time unit.

In response to determining that none of the at least one subband is activated for PDSCH rate match, the UE may determine the whole resources of the at least one subband are available for a PDSCH transmission in a time unit with a UL subband configured for UL transmission.

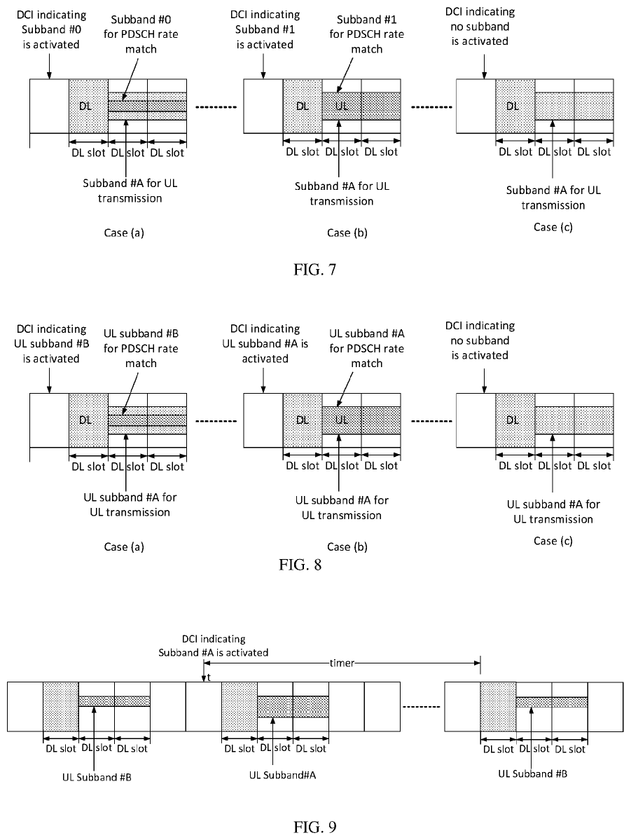

FIG. 7 is an exemplary method for determining subband for PDSCH rate match according to some embodiments of the present disclosure.

Referring to FIG. 7, it is assumed that two subbands, denoted as subband #0 and subband #1, are configured for PDSCH rate match. A UL subband #A is configured for UL transmission in the DL slots. Subband #0 and subband #1 for PDSCH rate match and subband #A for UL transmission may be configured via different RRC signaling. For example, subband #0 and subband #1 are configured in a DL BWP configuration, while UL subband #A is configured in a UL BWP configuration.

Referring to case (a), in response to receiving a DCI indicating that subband #0 for PDSCH rate match is activated, in the DL slots with UL subband #A, the PDSCH is rate matched around subband #0 (instead of UL subband #A) when the allocated PDSCH resource (partially or completely) includes subband #0. In such case, subband #0 for PDSCH rate match is within UL subband #A and may be occupied by UL signals. Other part of resources in UL subband #A can be used for PDSCH transmission.

Referring to case (b), in response to receiving a DCI indicating that subband #1 for PDSCH rate match is activated, in the DL slots with UL subband #A, a PDSCH is rate matched around subband #1 when the allocated PDSCH resource (partially or completely) includes subband #0. Subband #1 has the same size with UL subband #A and may be occupied by UL signals.

Referring to case (c), in response to receiving a DCI indicating that no subband is activated for PDSCH rate match, the UE may determine the whole resources of subband #0 and subband #1 are available for a PDSCH transmission in DL slots with UL subband #A.

According to some embodiments of the present disclosure, there may be no dedicated signaling configuring a subband(s) for PDSCH rate match. Instead, the configuration information which configures the at least one subband may be included in an RRC signaling configuring a UL BWP.

In such embodiments, the at least one subband may be at least one UL subband configured for the UE. The at least one UL subband may be configured for at least one of: UL transmission or PDSCH rate match. For example, one UL subband from the at least one UL subband may be configured for UL transmission, and another UL subband from the at least one UL subband may be activated for PDSCH rate match and is indicated to the UE.

In some cases, the at least one UL subband may be configured cell specifically. For example, the configuring information which configures the at least one UL subband may be included in RRC signaling (e.g., BWP-UplinkCommon as specified in 3GPP standard documents) that configures the common part of a UL BWP. Based on this, even when a UE is not configured with a UL subband(s) for UL transmission (e.g., PUSCH), it could get the subband configuration for PDSCH rate match.

In some embodiments, the indication may be included in a DCI (e.g., the indication may be a field included in DCI), and indicate that a UL subband (e.g., denoted as subband #S′) of the at least one UL subband is the active subband for PDSCH rate match or indicate none of the at least one UL subband is activated for PDSCH rate match. In an embodiment, the DCI may be a DCI scheduling a PDSCH transmission. In another embodiment, the DCI may be a group common DCI dedicated for active subband indication.

For example, the indication may indicate an ID or an index of UL subband #S′ from the at least one subband, which means that UL subband #S′ is the active subband for PDSCH rate match. In another example, the indication may have a pre-defined value, which means that none of the at least one UL subband is activated for PDSCH rate match.

In such embodiments, the UE may receive the DCI including the indication. Based on the indication, the UE may determine UL subband #S′ is the active subband for PDSCH rate match or determine none of the at least one UL subband is activated for PDSCH rate match.

In response to determining that none of the at least one subband is activated for PDSCH rate match, the UE may determine that the whole resources of a UL subband configured for UL transmission are available for a PDSCH transmission in a time unit with the UL subband.

In response to determining that UL subband #S′ is the active subband for PDSCH rate match, the UE may perform a rate match around UL subband #S′ for a PDSCH transmission. For example, a UE may be configured with a UL subband (e.g., denoted as UL subband #S″) for UL transmission, wherein UL subband #S″ is one of the at least one UL subband configured for the UE, and may be the same as or different from UL subband #S′. In the case that resources allocated for a PDSCH transmission in a time unit with UL subband #S″ include UL subband #S′, the UE may perform a rate match around UL subband #S′ for a PDSCH transmission in the time unit.

FIG. 8 is an exemplary method for determining subband for PDSCH rate match according to some embodiments of the present disclosure.

Referring to FIG. 8, it is assumed that two UL subbands, denoted as UL subband #A and UL subband #B, are configured for the UE, wherein UL subband #A is configured for UL transmission in the DL slots.

Referring to case (a) in FIG. 8, in response to receiving a DCI indicating that UL subband #B is activated for PDSCH rate match, in the DL slots with UL subband #A, the PDSCH is rate matched around UL subband #B (instead of UL subband #A) when the allocated PDSCH resource contains UL subband #B. In such case, UL subband #B for PDSCH rate match is within UL subband #A and may be occupied by UL signals. Other part of resources in UL subband #A can be used for PDSCH transmission.

Referring to case (b), in response to receiving a DCI indicating that UL subband #A is activated for PDSCH rate match, in the DL slots with UL subband #A, PDSCH is rate matched around UL subband #A when the allocated PDSCH resource contains UL subband #A. UL subband #A may be occupied by UL signals.

Referring to case (c), in response to receiving a DCI indicating that no UL subband is activated for PDSCH rate match, the UE may determine the whole resources of subband #A are available for a PDSCH transmission in DL slots with UL subband #A.

According to some embodiments of the present application, the at least one subband may be at least one UL subband configured for UL transmission. In some cases, the at least one UL subband may be configured cell specifically. For example, the configuring information which configures the at least one UL subband may be included in RRC signaling (e.g., BWP-UplinkCommon as specified in 3GPP standard documents) that configures the common part of a UL BWP.

In such embodiments, the BS may transmit an indication indicating an active subband (e.g., denoted as subband #S1) from the at least one UL subband for UL transmission. For example, the indication may indicate an ID or an index of UL subband #S1 from the at least one UL subband, which means that UL subband #S1 is the active subband for UL transmission.

In some embodiments, the indication may be included in a DCI (e.g., the indication may be a field included in DCI). That is, the active subband is dynamically indicated in a DCI. In an embodiment, the DCI may be a DCI scheduling a PDSCH transmission. In another embodiment, the DCI may be a group common DCI dedicated for active subband indication.

The UE may override a UL subband (e.g., UL subband #S2) of the at least one UL subband which is configured for a UL transmission with the dynamically indicated active subband (e.g., UL subband #S1 as stated above) for a UL transmission within a time period. The value of the time period may be configured or preconfigured for the UE. Within the time period, UL subband #S1 may be used for UL transmission (e.g., for scheduling PUSCH transmission). After the time period, UL subband #S2 may be reused for UL transmission (e.g., for scheduling PUSCH transmission). It should be noted that the dynamically indicated active subband for UL transmission herein may be independent of the active subband for PDSCH rate match as stated above.

FIG. 9 is an exemplary method for overriding a subband according to some embodiments of the present disclosure.

Referring to FIG. 9, it is assumed that two UL subbands, denoted as UL subband #A and UL subband #B, are configured for the UE, wherein UL subband #B is configured for UL transmission in the DL slots.

At a time instant t, the UE may receive a DCI including an indication which indicates that UL subband #A is activated for UL transmission.

In response to receiving the DCI, the UE may start a timer with a value equal to the value of the time period as stated above. When the timer is running, UL subband #A in the DL slots may be used for PUSCH transmission (e.g., the BS may schedule the resources in UL subband #A for PUSCH transmission). After the timer expires, UL subband #B in the DL slots may be used for PUSCH transmission (e.g., the BS may schedule the resources in UL subband #B for PUSCH transmission).

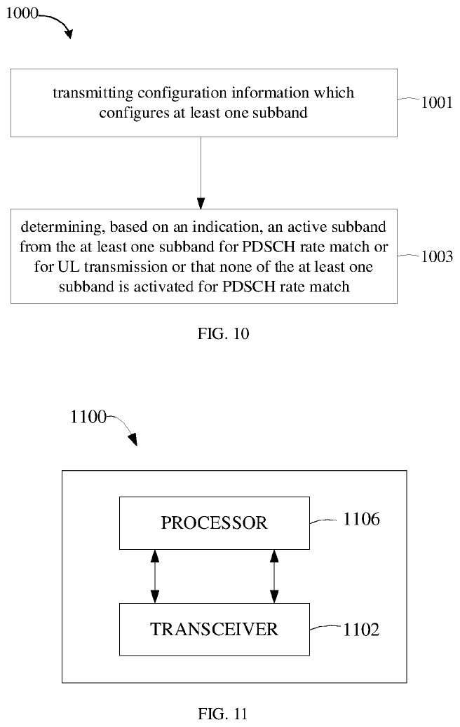

FIG. 10 is a flow chart illustrating an exemplary method for DL transmission in a full duplex system according to some embodiments of the present disclosure. The method in FIG. 10 may be implemented by a BS (e.g., BS 102 as shown in FIG. 1).

In the exemplary method shown in FIG. 10, in step 1001, a BS may transmit configuration information which configures at least one subband to a UE (e.g., UE 101 as shown in FIG. 1). In step 1003, the BS may determine, based on an indication, an active subband from the at least one subband for PDSCH rate match or for UL transmission or that none of the at least one subband is activated for PDSCH rate match.

According to some embodiments of the present disclosure, the at least one subband may be configured for PDSCH rate match. In such embodiments, the at least one subband for PDSCH rate match and the UL subband for UL transmission may be configured separately. That is, the at least one subband for PDSCH rate match is configured separately from the UL subband(s) configured for UL transmission.

In some embodiments of the present disclosure, the configuration information configuring the at least one subband may be included in an RRC signaling (e.g., RRC signaling #1).

In an embodiment of the present disclosure, RRC signaling #1 may be different from an RRC signaling (e.g., RRC signaling #2) configuring a UL subband(s) for UL transmission.

For example, the at least one subband for PDSCH rate match may be configured cell specifically. For instance, RRC signaling #1 may be RRC signaling (e.g., BWP-DownlinkCommon as specified in 3GPP standard documents) that configures the common part of a DL BWP. RRC signaling #2 may be an RRC signaling (e.g., BWP-UplinkCommon as specified in 3GPP standard documents) that configures the common part of a UL BWP.

In some embodiments of the present disclosure, a subband of the at least one subband for PDSCH rate match may be associated with a UL subband for UL transmission, e.g., a subband of the at least one subband is configured within a UL subband. In some embodiments of the present disclosure, each subband of the at least one subband for PDSCH rate match may be associated with a corresponding UL subband for UL transmission, e.g., each subband of the at least one subband may be configured within a corresponding UL subband.

According to some embodiments of the present disclosure, if the subband(s) for PDSCH rate match are not configured, the at least one subband (e.g., in step 1001) may be the configured UL subband(s) for UL transmission.

In some embodiments of the present disclosure, the at least one subband may be indexed such that each subband of the at least one subband may have an index. Such index may be used for indicating an active subband from the at least one subband. The specific operation will be illustrated below.

In some embodiments of the present disclosure, the indication may be included in a DCI (e.g., the indication may be a field included in DCI), and indicate that a subband (e.g., denoted as subband #S) of the at least one subband is the active subband for PDSCH rate match or indicates that none of the at least one subband is activated for PDSCH rate match.

For example, the indication may indicate an ID or an index of subband #S from the at least one subband, which means that subband #S is the active subband for PDSCH rate match. In another example, the indication may have a pre-defined value, which means that none of the at least one subband is activated for PDSCH rate match.

In an embodiment, the DCI may be a DCI scheduling a PDSCH transmission. In another embodiment, the DCI may be a group common DCI dedicated for active subband indication.

In such embodiments, the BS may transmit the DCI including the indication. Based on the indication, the BS may determine subband #S is the active subband for PDSCH rate match, or determine that none of the at least one subband is activated for PDSCH rate match.

In response to determining that subband #S is the active subband for PDSCH rate match, in the case that resources allocated for a PDSCH transmission in a time unit (e.g., in terms of slot, symbol, sub-slot, etc.) with a UL subband configured for UL transmission include subband #S, the BS may perform a rate match around subband #S for a PDSCH transmission in the time unit.

In response to determining that none of the at least one subband is activated for PDSCH rate match, the BS may determine the whole resources of the at least one subband are available for a PDSCH transmission in a time unit with a UL subband configured for UL transmission.

In some embodiments of the present disclosure, a rate match pattern may be used to configure the resources of a subband within the at least subband. In such embodiments, a rate match pattern may be associated with a subband within the at least subband. For example, the rate match pattern may be configured with an ID or an index of the subband (in other words, a configuration for the rate match pattern may include an ID or an index of the subband) such that the reserved resources indicated by the rate match pattern correspond to the subband. In such embodiments, the rate match pattern may be included in a rate match pattern group. An example for the rate match pattern and the rate match pattern group may refer to FIG. 6.

In such embodiments, the indication may indicate to activate a rate match pattern group including a rate match pattern associated with a subband of the at least one subband or indicate no rate match pattern group(s) including a rate match pattern(s) associated with the at least one subband is activated for PDSCH rate match.

In an embodiment, the indication may be included in a DCI (e.g., the indication may be a field included in DCI). For example, the DCI may be a DCI scheduling a PDSCH transmission. In another embodiment, the DCI may be a group common DCI dedicated for active subband indication.

In such embodiments, the BS may transmit the indication. In the case that the indication indicates to activate a rate match pattern group including a rate match pattern associated with a subband of the at least one subband, the BS may determine that the subband is the active subband for PDSCH rate match. In the case that the indication indicates no rate match pattern group(s) including a rate match pattern(s) associated with the at least one subband is activated for PDSCH rate match, the BS may determine that none of the at least one subband is activated for PDSCH rate match.

In response to determining the active subband for PDSCH rate match, in the case that resources allocated for a PDSCH transmission in a time unit with a UL subband configured for UL transmission include the active subband, the BS may perform a rate match around the active subband for a PDSCH transmission in the time unit.

In response to determining that none of the at least one subband is activated for PDSCH rate match, the BS may determine the whole resources of the at least one subband are available for a PDSCH transmission in a time unit with a UL subband configured for UL transmission.

According to some embodiments of the present disclosure, there may be no dedicated signaling configuring a subband(s) for PDSCH rate match. Instead, the configuration information which configures the at least one subband may be included in an RRC signaling configuring a UL BWP.

In such embodiments, the at least one subband may be at least one UL subband configured for the UE. The at least one UL subband may be configured for at least one of: UL transmission or PDSCH rate match.

In some cases, the at least one UL subband may be configured cell specifically. For example, the configuring information which configures the at least one UL subband may be included in RRC signaling (e.g., BWP-UplinkCommon as specified in 3GPP standard documents) that configures the common part of a UL BWP.

In some embodiments, the indication may be included in a DCI (e.g., the indication may be a field included in DCI), and indicate that a UL subband (e.g., denoted as subband #S′) of the at least one UL subband is the active subband for PDSCH rate match or indicate none of the at least one UL subband is activated for PDSCH rate match. In an embodiment, the DCI may be a DCI scheduling a PDSCH transmission. In another embodiment, the DCI may be a group common DCI dedicated for active subband indication.

For example, the indication may indicate an ID or an index of UL subband #S′ from the at least one subband, which means that UL subband #S′ is the active subband for PDSCH rate match. In another example, the indication may have a pre-defined value, which means that none of the at least one UL subband is activated for PDSCH rate match.

In such embodiments, the BS may transmit the DCI including the indication. Based on the indication, the BS may determine UL subband #S′ is the active subband for PDSCH rate match or determine none of the at least one UL subband is activated for PDSCH rate match.

In response to determining that none of the at least one subband is activated for PDSCH rate match, the BS may determine that the whole resources of a UL subband configured for UL transmission are available for a PDSCH transmission in a time unit with the UL subband.

In response to determining that UL subband #S′ is the active subband for PDSCH rate match, the BS may perform a rate match around UL subband #S′ for a PDSCH transmission. For example, the BS may configure a UL subband (e.g., denoted as UL subband #S″) for UL transmission, wherein UL subband #S″ is one of the at least one UL subband configured for the UE, and may be the same as or different from UL subband #S′. In the case that resources allocated for a PDSCH transmission in a time unit with UL subband #S″ include UL subband #S′, the BS may perform a rate match around UL subband #S′ for a PDSCH transmission in the time unit.

According to some embodiments of the present application, the at least one subband may be at least one UL subband configured for UL transmission. In some cases, the at least one UL subband may be configured cell specifically. For example, the configuring information which configures the at least one UL subband may be included in RRC signaling (e.g., BWP-UplinkCommon as specified in 3GPP standard documents) that configures the common part of a UL BWP.

In such embodiments, the BS may transmit an indication indicating an active subband (e.g., denoted as subband #S1) from the at least one UL subband for UL transmission. For example, the indication may indicate an ID or an index of UL subband #S1 from the at least one UL subband, which means that UL subband #S1 is the active subband for UL transmission.

In some embodiments, the indication may be included in a DCI (e.g., the indication may be a field included in DCI). That is, the active subband is dynamically indicated in a DCI. In an embodiment, the DCI may be a DCI scheduling a PDSCH transmission. In another embodiment, the DCI may be a group common DCI dedicated for active subband indication.

The BS may override a UL subband (e.g., UL subband #S2) of the at least one UL subband which is configured for a UL transmission with the dynamically indicated active subband (e.g., UL subband #S1 as stated above) for a UL transmission within a time period. The value of the time period may be configured or preconfigured for the UE. Within the time period, UL subband #S1 may be used for UL transmission (e.g., for scheduling PUSCH transmission). After the time period, UL subband #S2 may be reused for UL transmission (e.g., for scheduling PUSCH transmission). It should be noted that the dynamically indicated active subband for UL transmission herein may be independent of the active subband for PDSCH rate match as stated above.

Referring back to FIG. 9 as an example, in response to transmitting the DCI, the BS may start a timer with a value equal to the value of the time period as stated above. When the timer is running. UL subband #A in the DL slots may be used for PUSCH transmission (e.g., the BS may schedule the resources in UL subband #A for PUSCH transmission). After the timer expires, UL subband #B in the DL slots may be used for PUSCH transmission (e.g., the BS may schedule the resources in UL subband #B for PUSCH transmission).

FIG. 11 illustrates a simplified block diagram of an exemplary apparatus for DL transmission in a full duplex system according to some embodiments of the present disclosure. As shown in FIG. 11, the apparatus 1100 may include at least one processor 1106 and at least one transceiver 1102 coupled to the processor 1106. The apparatus 1100 may be a UE or a BS.

Although in this figure, elements such as the at least one transceiver 1102 and processor 1106 are described in the singular, the plural is contemplated unless a limitation to the singular is explicitly stated. In some embodiments of the present disclosure, the transceiver 1102 may be divided into two devices, such as a receiving circuitry and a transmitting circuitry. In some embodiments of the present disclosure, the apparatus 1100 may further include an input device, a memory, and/or other components.

In some embodiments of the present disclosure, the apparatus 1100 may be a UE. The transceiver 1102 and the processor 1106 may interact with each other so as to perform the operations with respect to the UE described in FIGS. 1-11. In some embodiments of the present disclosure, the apparatus 1100 may be a BS. The transceiver 1102 and the processor 1106 may interact with each other so as to perform the operations with respect to the BS described in FIGS. 1-10.

In some embodiments of the present disclosure, the apparatus 1100 may further include at least one non-transitory computer-readable medium.

For example, in some embodiments of the present disclosure, the non-transitory computer-readable medium may have stored thereon computer-executable instructions to cause the processor 1106 to implement the method with respect to the UE as described above. For example, the computer-executable instructions, when executed, cause the processor 1106 interacting with transceiver 1102 to perform the operations with respect to the UE described in FIGS. 1-10.

In some embodiments of the present disclosure, the non-transitory computer-readable medium may have stored thereon computer-executable instructions to cause the processor 1106 to implement the method with respect to the BS as described above. For example, the computer-executable instructions, when executed, cause the processor 1106 interacting with transceiver 1102 to perform the operations with respect to the BS described in FIGS. 1-10.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE), comprising:
at least one memory; and
at least one processor coupled with the at least one memory and configured to cause the UE to:
a receive configuration information which configures at least one subband; and
determine, based on an indication, an active subband from the at least one subband for physical downlink shared channel (PDSCH) rate match or for uplink (UL) transmission or that none of the at least one subband is activated for PDSCH rate match.

2. The UE of claim 1, wherein the configuration information is included in a first radio resource control (RRC) signaling, and the at least one subband is configured for PDSCH rate match.

3. The UE of claim 2, wherein the first RRC signaling is different from a second RRC signaling configuring a UL subband(s) for UL transmission.

4. The UE of claim 1, wherein the at least one subband is a UL subband(s) configured for UL transmission.

5. The UE of claim 2, wherein a subband from the at least one subband is associated with a UL subband configured for UL transmission.

6. The UE of claim 1, wherein the indication is included in a downlink control information (DCI), and the indication indicates that a subband of the at least one subband is the active subband for PDSCH rate match or indicates that none of the at least one subband is activated for PDSCH rate match.

7. The UE of claim 1, wherein the indication indicates to activate a rate match pattern group including a rate match pattern associated with a subband of the at least one subband or indicates that no rate match pattern group including a rate match pattern associated with the at least one subband is activated for PDSCH rate match, and determining the active subband from the at least one subband for PDSCH rate match comprises:
determining that the subband is the active subband for PDSCH rate match.

8. The UE of claim 7, wherein the at least one processor is configured to cause the UE to:
perform a rate match around the subband for a PDSCH transmission in a time unit with a UL subband if resources allocated for the PDSCH transmission in the time unit includes the subband.

9. The UE of claim 7, wherein the at least one processor is configured to cause the UE to:
determine the whole resources of the at least one subband are available for a PDSCH transmission in a time unit with a UL subband if none of the at least one subband is activated for PDSCH rate match.

10. The UE of claim 1, wherein the configuration information is included in radio resource control (RRC) signaling configuring a UL bandwidth part (BWP).

11. The UE of claim 1, wherein the at least one subband comprises at least one UL subband configured for at least one of UL transmission or PDSCH rate match.

12. The UE of claim 11, wherein the indication is included in a downlink control information (DCI), and the indication indicates that a first UL subband of the at least one UL subband is the active subband for PDSCH rate match or for UL transmission or indicate that none of the at least one UL subband is activated for PDSCH rate match.

13. The UE of claim 12, wherein the at least one processor is configured to cause the UE to:
perform a rate match around the first UL subband for a PDSCH transmission in a time unit with a second UL subband of the at least one UL subband for UL transmission if resources allocated for the PDSCH transmission in the time unit includes the first UL subband.

14. A base station (BS), comprising:
at least one memory; and
at least one processor coupled with the at least one memory and configured to cause the base station to:
transmit configuration information which configures at least one subband; and
determine, based on an indication, an active subband from the at least one subband for physical downlink shared channel (PDSCH) rate match or for uplink (UL) transmission or that none of the at least one subband is activated for PDSCH rate match.

15. A method performed by a user equipment (UE), the method comprising:
receiving configuration information which configures at least one subband; and
determining, based on an indication, an active subband from the at least one subband for physical downlink shared channel (PDSCH) rate match or for uplink (UL) transmission or that none of the at least one subband is activated for PDSCH rate match.

16. A processor for wireless communication, comprising:
at least one controller coupled with at least one memory and configured to cause the processor to:
receive configuration information which configures at least one subband; and
determine, based on an indication, an active subband from the at least one subband for physical downlink shared channel (PDSCH) rate match or for uplink (UL) transmission or that none of the at least one subband is activated for PDSCH rate match.

17. The processor of claim 16, wherein the configuration information is included in a first radio resource control (RRC) signaling, and the at least one subband is configured for PDSCH rate match.

18. The processor of claim 17, wherein the first RRC signaling is different from a second RRC signaling configuring a UL subband(s) for UL transmission.

19. The processor of claim 16, wherein the at least one subband is a UL subband(s) configured for UL transmission.

20. The processor of claim 17, wherein a subband from the at least one subband is associated with a UL subband configured for UL transmission.
